(19) United States
(12) Patent Application Publication
(10) Pub. No.: US 2003/0058455 A1
(43) Pub. Date: Mar. 27, 2003

(54) Three-dimensional shape measuring apparatus

(76) Inventors: Akimitsu Ebihara, Kyoto-shi (JP); Toshio Kawano, Osaka (JP); Yoshihisa Abe, Osaka (JP)

Correspondence Address: MCDERMOTT, WILL & EMERY, 600 13th Street, N.W., Washington, DC, 20005-3096, US

(21) Appl. No.: 10/237,176

(22) Filed: Sep. 9, 2002

(30) Foreign Application Priority Data
Sep. 14, 2001 (JP) 2001-279465
Sep. 14, 2001 (JP) 2001-279475

(51) Int. Cl. G01B 11/00

(52) U.S. Cl. 356/601; 356/612

(57) ABSTRACT

A three-dimensional shape measuring apparatus has a point light source for radiating illumination light diverging in the shape of an elliptical cone, a slit illumination system for imaging the illumination light into the shape of a slit, an objective system for imaging the illumination light toward a measurement object and for imaging reflected light traveling back from the measurement object, a beam splitter for separating the optical paths of the illumination light entering the objective system and of the reflected light exiting from the objective system, and a sensor for detecting the amount of the reflected light exiting from the objective system. The slit illumination system has a collimator system for converting the diverging illumination light into a parallel beam having an elliptical section, an anamorphic prism system for expanding the illumination light only in the direction of the ellipse major axis, a cylindrical system for imaging the illumination light only in the direction of the ellipse minor axis, and a polarization direction converting device for converting the polarization direction of the illumination light so that it is incident on a prism surface of the anamorphic prism system with a maximum transmittance. The illumination light enters the objective system obliquely such that the illumination light, when passing through the pupil of the objective system, passes through one half of the pupil relative to the optical axis of the objective system, and, of the reflected light, the portion that passes through that one half of the pupil is intercepted.

This application is based on Japanese Patent Applications Nos. 2001-279465 and 2001-279475 both filed on Sep. 14, 2001, the contents of which are hereby incorporated by reference.

### BACKGROUND OF THE INVENTION

1. Field of the Invention

The present invention relates to a three-dimensional shape measuring apparatus, and more particularly to a three-dimensional shape measuring apparatus relying on confocal detection.

2. Description of the Prior Art

One known way of measuring a three-dimensional shape is by confocal detection. There are different types of confocal detection, including, for example, methods using illumination light in the shape of a pinhole and methods using illumination light in the shape of a slit. A method using slit-shaped illumination light permits acquisition of height information at many points in a single path of scanning, and is therefore favorable for the speeding-up of three-dimensional shape measurement. However, a point light source needs to be expanded into the shape of a slit, and this reduces the amount of light per unit area. As a result, in cases where the measurement object has low reflectance, or the measured surface forms a large angle with the optical axis, it is difficult to obtain satisfactorily high measurement accuracy. This necessitates a slit illumination optical system that produces illumination light in the shape of a slit over the entire length of the longer sides of which the light is uniformly and satisfactorily intense. One common way of expanding illumination light in the direction of the longer sides of a slit is by using an expander optical system designed for a laser beam. For example, Japanese Patent Application Laid-Open No. 2000-105203 discloses, as a slit illumination optical system for use in a defect inspection apparatus, one including an expander optical system composed of a group of lens elements.

On the other hand, a method using pinhole-shaped illumination light, in its typical form, operates basically as follows. Illumination light emanates from a light source, and passes through an illumination pinhole, where the light forms an image of the light source. The light is then reflected from a polarizing beam splitter so as to be projected, through an objective optical system, onto the surface to be measured on a measurement object. The light reflected from the measured surface passes through the objective optical system, and is then transmitted through the polarizing beam splitter so as to be directed to a detection pinhole. The light passes through the detection pinhole, and reaches a sensor, which detects the amount of light it receives.

The illumination pinhole and the detection pinhole are located in optically equivalent (i.e., confocal) positions with respect to the objective optical system. Therefore, when the measured surface is located in a position conjugate with the illumination pinhole, the detection pinhole is also conjugate with the measured surface, permitting the maximum amount of illumination light to pass through the detection pinhole. However, when the measured surface is located off the position conjugate with the illumination pinhole, far less light passes through the detection pinhole. Thus, from the imaging condition that permits the maximum amount of light to be detected by the sensor, it is possible to determine the height of the measurement object (i.e., the dimension of the object in the direction parallel to the optical axis.).

However, with a method using slit-shaped illumination light, when, as disclosed in Japanese Patent Application Laid-Open No. 2000-105203 mentioned above, an expander optical system is composed of a group of lens elements, illumination light has lower luminous flux density at both ends of a slit in the direction of its longer sides, that is, light intensity is not uniform, decreasing toward each end along the direction of the longer sides of the slit. Moreover, as the factor of magnification increases, the total length of an expander optical system increases. Furthermore, when a laser beam collimated by a collimator lens is passed through an expander optical system composed of a group of lens elements, the beam is expanded not only in the direction of the longer sides but also in the direction of the shorter sides of a slit. For this reason, to obtain the desired NA (numerical aperture) in a slit imaging optical system, i.e., an optical system for imaging collimated and then expanded light into the shape of a slit, the slit imaging optical system needs to be given a long focal length, making the total length of the slit illumination optical system incorporating it accordingly long.

On the other hand, with a method using pinhole-shaped illumination light, if the measured surface includes diffusive-surface patches (for example, if it consists of specular-surface and diffusive-surface patches mixed together), even when the measured surface is located off the position conjugate with the illumination pinhole, part of the diffusively reflected light follows the same path as illumination light would, that is, it may pass through the detection pinhole and be detected by the sensor. This produces measurement noise, lowering the accuracy with which the height of the measurement object is measured.

### SUMMARY OF THE INVENTION

An object of the present invention is to provide a three-dimensional shape measuring apparatus provided with a slit illumination optical system that is compact but nevertheless produces uniform and intense illumination light.

Another object of the present invention is to provide a three-dimensional shape measuring apparatus that permits highly accurate measurement of the height of a measurement object.

To achieve the above objects, according to one aspect of the present invention, in a three-dimensional shape measuring apparatus including a point light source for radiating illumination light diverging in the shape of an elliptical cone and a slit illumination optical system for imaging the illumination light from the point light source into the shape of a slit, the slit illumination optical system is provided with: a collimator optical system for converting the diverging illumination light into a parallel beam having an elliptical section, an anamorphic prism system for expanding the illumination light only in the direction of the major axis of the elliptical section thereof, a cylindrical optical system for imaging the illumination light only in the direction of the minor axis of the elliptical section thereof, and a polarization direction converting device for converting the polarization direction of the illumination light so that the illumination light is incident on a prism surface of the anamorphic prism system with a maximum transmittance.

According to another aspect of the present invention, in a three-dimensional shape measuring apparatus relying on confocal detection and including a light source for radiating illumination light, an objective optical system for imaging the illumination light from the light source toward a measurement object and for imaging the reflected light traveling back from the measurement object, a beam splitter for separating the optical path of the illumination light entering the objective optical system and the optical path of the reflected light exiting from the objective optical system, and a sensor for detecting the amount of the reflected light exiting from the objective optical system, the illumination light enters the objective optical system obliquely such that the illumination light, when passing through the pupil of the objective optical system, passes through one half of the pupil relative to the optical axis of the objective optical system, and, of the reflected light from the measurement object, a portion that passes through that one half of the pupil is intercepted.

### BRIEF DESCRIPTION OF THE DRAWINGS

This and other objects and features of the present invention will become clear from the following description, taken in conjunction with the preferred embodiments with reference to the accompanying drawings in which:

FIGS. 1A and 1B are optical construction diagrams schematically showing an example of the construction of a slit illumination optical system embodying the invention;

FIG. 2 is a construction diagram schematically showing a three-dimensional shape measuring apparatus incorporating the slit illumination optical system of FIG. 1;

FIG. 3 is a diagram illustrating the relationship between the beam shape of a laser beam, the light intensity distribution on a section thereof, and the orientation of the slit;

FIG. 4 is a diagram illustrating the operation of a variable ND filter for enhancing the dynamic range of a measurement system;

FIGS. 5A and 5B are optical path diagrams illustrating how a laser beam is shaped by an expander optical system;

FIGS. 6A and 6B are diagrams illustrating how diffusively reflected light affects measurement accuracy;

FIGS. 7A, 7B, and 7C are diagrams illustrating the relationship between the region in which the reflected light is passed and the region in which it is intercepted, as observed on the pupil plane;

FIG. 8 is a perspective view showing how the light-intercepting mask is arranged in the three-dimensional shape measuring apparatus of FIG. 2;

FIGS. 9A to 9F are diagrams illustrating the variation of the defocused optical path with respect to the light-receiving surface of the line sensor, the variation of light intensity distribution, and the variation of the amount of light detected; and

FIGS. 10A and 10B are optical construction diagrams schematically showing a three-dimensional shape measuring apparatus having a relay optical system arranged on the line sensor side.

### DESCRIPTION OF THE PREFERRED EMBODIMENTS

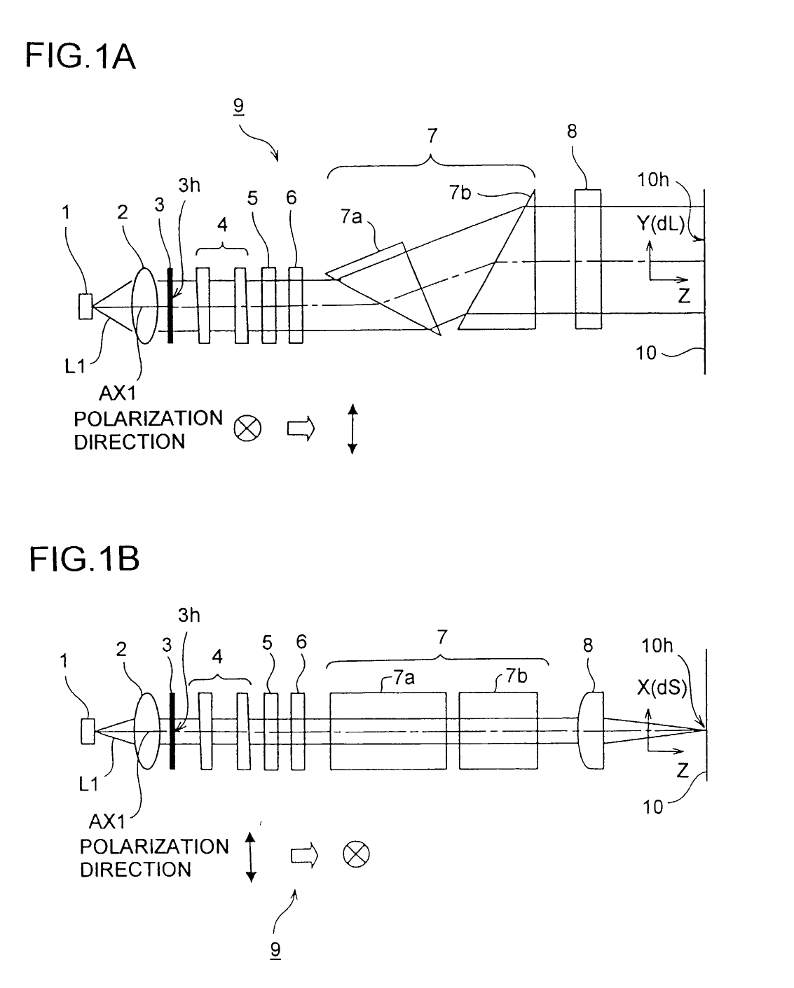

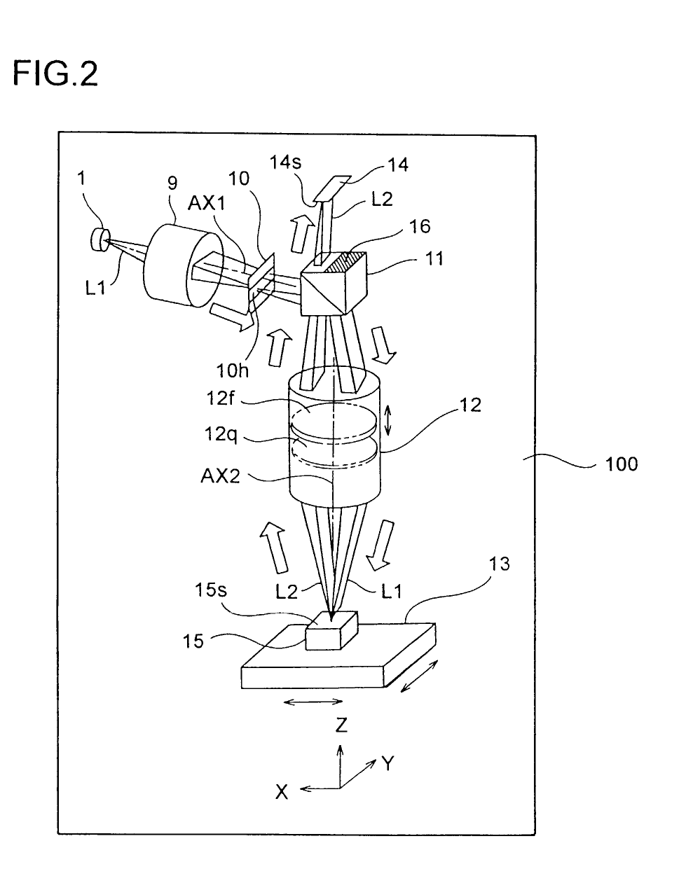

Hereinafter, three-dimensional shape measuring apparatus embodying the present invention will be described with reference to the drawings. FIGS. 1A and 1B show an example of the configuration of the slit illumination optical system 9 that constitutes a part of a three-dimensional shape measuring apparatus. FIG. 2 shows a three-dimensional shape measuring apparatus 100 relying on confocal detection using slit-shaped illumination light and provided with the slit illumination optical system 9 of FIG. 1.

In FIGS. 1A, 1B, and 2, reference numeral 1 represents a laser diode, 2 represents a collimator lens, 3 represents a rectangular-aperture plate, 4 represents paired wedge prisms, 5 represents a half-wave plate, 6 represents a variable-ND (neutral density) filter, 7 represents paired anamorphic prisms, 8 represents a cylindrical lens, 9 represents a slit illumination optical system, 10 represents a slit mask, 11 represents a polarizing beam splitter, 12 represents an objective optical system, 13 represents an XY stage, 14 represents a line sensor, 15 represents a measurement object, and 16 represents a light-intercepting mask. Reference symbol L1 represents a laser beam (illumination light), L2 represents reflected light, AX1 represents the optical axis of the slit illumination optical system 9, and AX2 represents the optical axis of the objective optical system 12. In each diagram, X, Y, and Z indicate the directions that are perpendicular to one another and with respect to which optical paths are shown in their developed (straightened-out) state. Thus, the plane of FIG. 1A is a YZ section, and the plane of FIG. 1B is an XZ section.

The laser diode 1 is a point light source that radiates a laser beam L1 as illumination light. The laser beam L1 radiated from the laser diode 1 is a Gaussian beam that diverges in the shape of an elliptical cone. The laser beam L1 radiated from the laser diode 1 is imaged in the shape of a slit in the position where the slit mask 10 has an opening (i.e., where a slit 10h is located) by the slit illumination optical system 9 composed of the collimator lens 2, rectangular-aperture plate 3, paired wedge prisms 4, half-wave plate 5, variable-ND filter 6, paired anamorphic prisms 7, and cylindrical lens 8. How this is achieved will be described below.

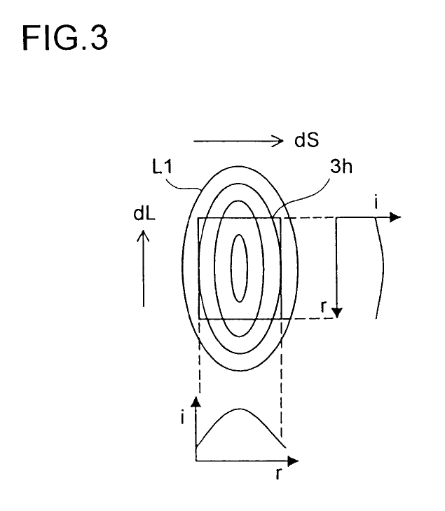

The laser beam L1 radiated as a diverging beam from the laser diode 1 is first converted into a collimated (i.e., parallel) beam by the collimator lens 2, which is a rotation-symmetric collimator optical system. Then, the laser beam L1 passes through a rectangular aperture 3h of the rectangular-aperture plate 3, and is thereby trimmed into a beam with the desired sectional shape. FIG. 3 shows the relationship between the beam shape of the laser beam L1, the light intensity distribution in the actually used portion of the Gaussian beam diverging in the shape of an elliptical cone, i.e., the portion thereof that corresponds to the rectangular aperture 3h (i represents light intensity, and r represents position across a beam diameter), and the orientation of the slit as indicated by directions dL and dS. As shown in FIG. 3, the laser diode 1 is so arranged that the direction of the major axis of the elliptical section of the laser beam L1 coincides with the direction dL of the longer sides of the slit 10h. This makes it possible to increase light use efficiency while maintaining substantially uniform light intensity distribution in the direction dL of the longer sides of the slit.

Having passed through the rectangular aperture 3h, the laser beam L1 enters the paired wedge prisms 4. The paired wedge prisms 4 serve as an optical axis deflector that permits the imaging position of the laser beam L1 to be fine-adjusted to the desired position. By rotating the lens barrel of the paired wedge prisms 4 about the optical axis AX1, the image of the light source in the shape of a slit (described later) can be translationally shifted very finely. By fine-adjusting the position of the laser beam L1 in this way, when optical adjustments are made, the position in which the slit-shaped image is formed can be adjusted to the position of the slit mask 10.

Having exited from the paired wedge prisms 4, the laser beam L1 passes through the half-wave plate 5, variable-ND filter 6, paired anamorphic prisms 7, and cylindrical lens 8 in this order, and then forms an image of the light source in the shape of a slit at the slit 10h. As shown in FIGS. 1A and 1B, the half-wave plate 5 serves as a polarization direction converting device that rotates the polarization direction of the laser beam L1 through 90°. The paired anamorphic prisms 7 are composed of a first and a second prism 7a and 7b, and serve as an expander optical system that expands the laser beam L1 only in the direction of the major axis of its elliptical section (i.e., in the direction dL of the longer sides of the slit). Like a common laser diode, the laser diode 1 radiates the laser beam L1 in such a way that the laser beam L1 is polarized parallel to the junction surface of the laser diode 1 (i.e., in the direction of the minor axis of the elliptical section of the beam in the shape of an elliptical cone). Moreover, as described above, the laser diode 1 is so arranged that the direction of the major axis of the elliptical section of the laser beam L1 coincides with the direction dL of the longer sides of the slit (FIG. 3). Thus, the laser beam L1 is converted from S-polarized to P-polarized light by the half-wave plate 5, and then enters the paired anamorphic prisms 7.

As the result of the conversion of the polarization direction by the half-wave plate 5, the laser beam L1 is incident on the prism surfaces of the paired anamorphic prisms 7 (in particular, the first surface of each of the first and second prisms 7a and 7b) with a maximum transmittance. This minimizes the loss of light in the paired anamorphic prisms 7, and thus contributes to high light use efficiency. Furthermore, by making the angle of incidence as close to the Brewster's angle as possible, it is possible to eliminate the need for anti-reflection coatings on the incident surfaces of the prisms. Moreover, since the direction of polarization coincides with the orientation of the slit, the laser beam L1 can pass through the slit with satisfactory efficiency. Though not illustrated in FIG. 1, a polarizing plate may be arranged immediately on the downstream side of the half-wave plate 5 to make the polarization direction of the laser beam L1 uniform with higher accuracy.

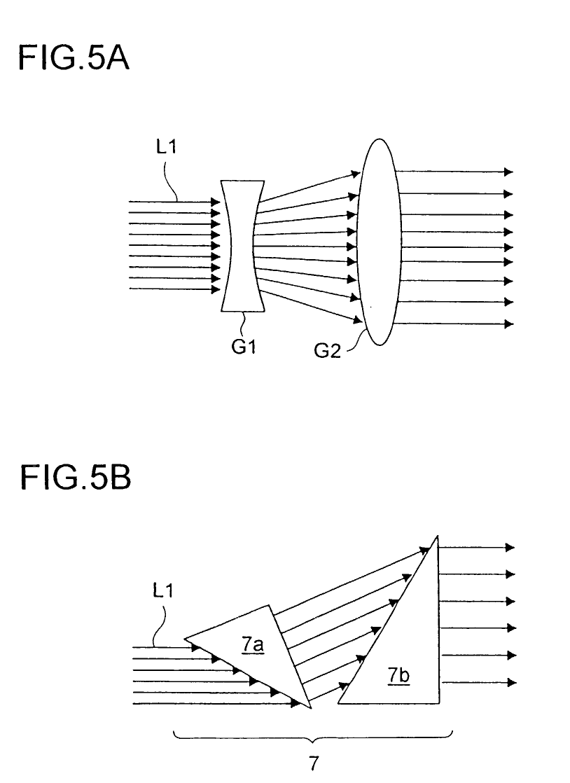

The paired anamorphic prisms 7 expand the laser beam L1 only in the direction dL of the longer sides of the slit. This makes it possible to obtain the desired slit length while keeping the beam width in the direction dS of the shorter sides of the slit unchanged. As a result, it is possible to obtain the desired NA (numerical aperture) without increasing the focal length of the cylindrical lens 8, which serves as a slit imaging optical system. This helps make the slit illumination optical system 9 small in total length and thus compact. As shown in FIG. 5A, a beam can be expanded only in one direction also by using as an expander optical system a group of lens elements composed of a negative cylindrical lens element GI and a positive cylindrical lens element G2. However, as shown in FIG. 5B, using paired anamorphic prisms 7 results in less lowering of luminous flux density at both ends in the direction of expansion than using a group of lens elements G1 and G2. Thus, the use of the paired anamorphic prisms 7 is effective also in making light intensity uniform in the direction of expansion, i.e., in the direction dL of the longer sides of the slit.

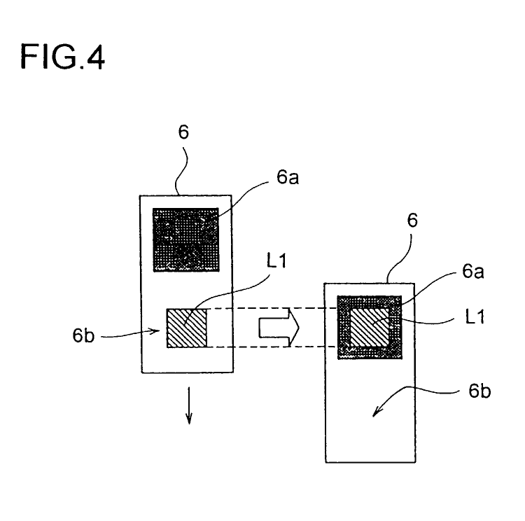

As shown in FIG. 4, the variable-ND filter 6 has an ND-deposited portion 6a having an ND film vapor-deposited on a glass substrate and non-ND-deposited portion 6b having no ND film vapor-deposited on a glass substrate. The variable-ND filter 6 is switchable in such a way that either the ND-deposited portion 6a or the non-ND-deposited portion 6b is placed in the optical path of the laser beam L1 so that the laser beam L1 passes through either of them.

When the measurement object 15 is measured to determine its height (along the Z axis), it is scanned twice, in one way and back. Specifically, the measurement object 15 is scanned first in one way, from bottom to top along the Z axis, with the laser beam L1 passing through the non-ND-deposited portion 6b, and then in the reverse direction, from top to bottom along the Z axis, with the laser beam L1 passing through the ND-deposited portion 6a. In this way, by switching the variable-ND filter 6, it is possible to switch the brightness of the illumination by the laser beam L1, and thereby enlarge the dynamic range of measurement by the line sensor 14. This makes it possible to widen the range of reflectance measurable on the measurement object 15.

Having been expanded in the direction dL of the longer sides of the slit by the paired anamorphic prisms 7, the laser beam L1 is then imaged only in the direction of the minor axis of its elliptical section (i.e., the direction dS of the shorter sides of the slit, FIG. 1B) by the cylindrical lens 8 serving as a slit imaging optical system. Thus, the laser beam L1 is kept in a collimated state in the direction of the major axis of its elliptical section (i.e., the direction dL of the longer sides of the slit, FIG. 1A). The laser beam L1 is imaged at the slit 10h of the slit mask 10. By imaging a beam in the shape of a slit and then making it pass through a slit mask 10 in this way, i.e., by the use of so-called critical illumination, it is possible to reduce the loss of light. Instead of forming an image of the light source at the slit 10h through the slit illumination optical system 9, a slit light source that radiates a divergent beam of light similar to such a light source image may be arranged at the slit 1 oh.

As shown in FIG. 2, the slit illumination optical system 9 is arranged at an angle relative to the optical axis AX2 of the objective optical system 12. That is, the optical axis AX1 of the slit illumination optical system 9 is inclined relative to a normal to the optical axis AX2 of the objective optical system 12. Thus, having passed through the slit 10h of the slit mask 10, the laser beam L1 enters the objective optical system 12 as obliquely incident illumination light. Here, the laser beam L1 enters the objective optical system 12 by way of the polarizing beam splitter 11. The polarizing beam splitter 11 serves as a polarization separation device that separates the optical path of the illumination light L1 entering the objective optical system 12 and the optical path of the reflected light L2 exiting from the objective optical system 12. Since the laser beam L1 as illumination light is polarized in the Y direction, it enters the polarizing beam splitter 11 as S-polarized light. Thus, the laser beam L1 has its optical path deflected toward the objective optical system 12 by the polarizing beam splitter 11.

The objective optical system 12 is a both-side telecentric optical system, meaning that it images the illumination light L1 in the shape of a slit toward the measurement object 15 and also images the reflected light L2 from the measurement object 15 in the shape of a slit toward the line sensor 14. Within this objective optical system 12, a quarter-wave plate 12q is arranged as a polarization direction converting device. The illumination light L1, having obliquely entered the objective optical system 12, passes through the quarter-wave plate 12q while traveling in one half of the objective optical system 12 relative to the optical axis AX2. On the other hand, the reflected light L2 from the measured surface 15s of the measurement object 15 passes through the quarter-wave plate 12q while traveling in the other half of the objective optical system 12 relative to the optical axis AX2.

As the result of the optical paths running in both ways through the quarter-wave plate 12q as described above, the polarization direction of the reflected light L2 is rotated through 90° relative to that of the illumination light L1. Thus, the reflected light L2 exiting from the objective optical system 12 enters the polarizing beam splitter 11 as P-polarized light. This permits the reflected light L2 to be transmitted through the polarizing beam splitter 11. The reflected light L2 transmitted through the polarizing beam splitter 11 is incident on the light-receiving surface 14s of the line sensor 14. Instead of converting the polarization directions of both the illumination light L1 and the reflected light L2 by the use of the quarter-wave plate 12q, a half-wave plate may be used to convert the polarization direction of either the illumination light L1 or the reflected light L2.

The line sensor 14 is a CCD (charge-coupled device) with a one-dimensional array. The line sensor 14 is arranged and fixed in such a way that its light-receiving surface 14s, composed of a plurality of light-receiving elements, is located in a position confocal with the slit 10h, and that an image of the measurement object 15 is projected onto the light-receiving surface 14s. Thus, both the slit 10h and the light-receiving surface 14s are arranged in a position conjugate with the measurement object 15; that is, they are located in confocal, i.e., optically equivalent, positions with respect to the objective optical system 12. Accordingly, when the focus is on the measured surface 15s of the measurement object 15, the reflected light L2 is imaged on the light-receiving surface 14s of the line sensor 14, i.e., a position conjugate with the measured surface 15s, where the amount of the reflected light L2 is detected pixel by pixel.

Within the objective optical system 12, a focusing lens unit 12f is arranged. As the focusing lens unit 12f is moved, only the image-side conjugate position (i.e., the conjugate position on the measurement object 15 side) is moved, and thereby scanning in the height direction of the measurement object 15 (i.e. the Z direction) is achieved. In this way, scanning in the Z direction is achieved with a simple structure that involves solely the movement of the focusing lens unit 12f. This makes it possible to miniaturize the scanning mechanism and increase the scanning speed. The XY stage 13 moves in the X and Y directions together with the measurement object 15 placed on it, and thereby changes the relative positions of the measurement object 15 and the illumination light L1 in the X and Y directions. This permits the measurement object 15 to be measured over the entire measurement area.

The three-dimensional measurement of the measurement object 15 is achieved in the following manner. The dimension in the X direction is determined by scanning the measurement object 15 while it is moved by the XY stage 13. The dimension in the Y direction is determined from the size of the image projected onto the light-receiving surface 14s by the objective optical system 12. When the projected image lies outside the light-receiving surface 14s in the Y direction, the XY stage 13 is moved in the Y direction. The dimension in the Z direction (i.e., the direction parallel to the optical axis AX2), namely the height, is determined, while the focusing lens unit 12f is moved along the optical axis AX2, by monitoring the variation in the output from each light-receiving element of the line sensor 14 and determining the position of the focusing lens unit 12f where the measurement object 15 is focused on the light-receiving surface 14s (i.e. where the output from each light-receiving element reaches its peak as the result of the measured surface 15s and the light-receiving surface 14s coming into a conjugate relationship). In this way, by moving the focusing lens unit 12f while the XY stage 13 is moved together with the measurement object 15 placed on it, the sectional shapes of the measurement object 15 on different planes are sequentially detected, on the basis of which the three-dimensional shape of the measurement object 15 is determined through calculations.

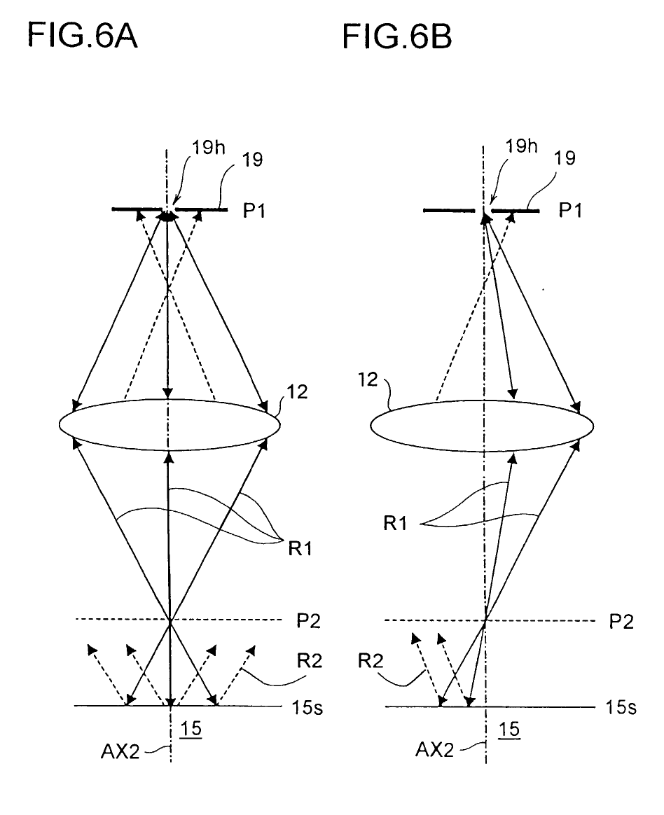

When the height of a measurement object of which the surface consists of, for example, tiny specular-surface and diffusive-surface patches mixed together is measured by the use of a common confocal optical system, even when the objective optical system is not focused on the measured surface, part of the light diffusively reflected from the diffusive-surface patches may follow the same path as the light for illuminating the measurement object and reach the sensor, affecting the measurement accuracy. This is illustrated in FIGS. 6A and 6B. FIG. 6A shows a case in which full-aperture illumination is adopted, and FIG. 6B shows a case in which obliquely incident illumination is adopted. In either case, although the measured surface 15s is located off the image-side conjugate position P2, part R1 of the diffusively reflected light R1 and R2 passes through a pinhole 19h of a pinhole plate 19 arranged in the object-side conjugate position P1. In this way, even if a pinhole plate 19 is arranged as a spatial filter, the diffusively reflected light R1 passes through the pinhole 19h. As a result, during the scanning of the measurement object 15 in the height direction, the diffusively reflected light R1 affects, as noise, the accuracy with which the height is measured at which the output from the sensor reaches its peak. This produces errors between the height data of specular-surface patches and those of diffusive-surface patches

One known way of intercepting the diffusively reflected light R1 described above is by keeping it from reaching the sensor by adopting an optical construction composed of an illumination optical system having an optical axis inclined relative to a normal to the stage surface on which the measurement object is placed and a condenser optical system having an optical axis aligned with the regular reflection of the optical axis of the illumination optical system. This construction, however, requires, to achieve scanning in the height direction, a mechanism that permits the entire optical system or the stage to be moved in the vertical direction. This inevitably enlarges the overall scale of the apparatus, and is thus ineffective in increasing the scanning speed.

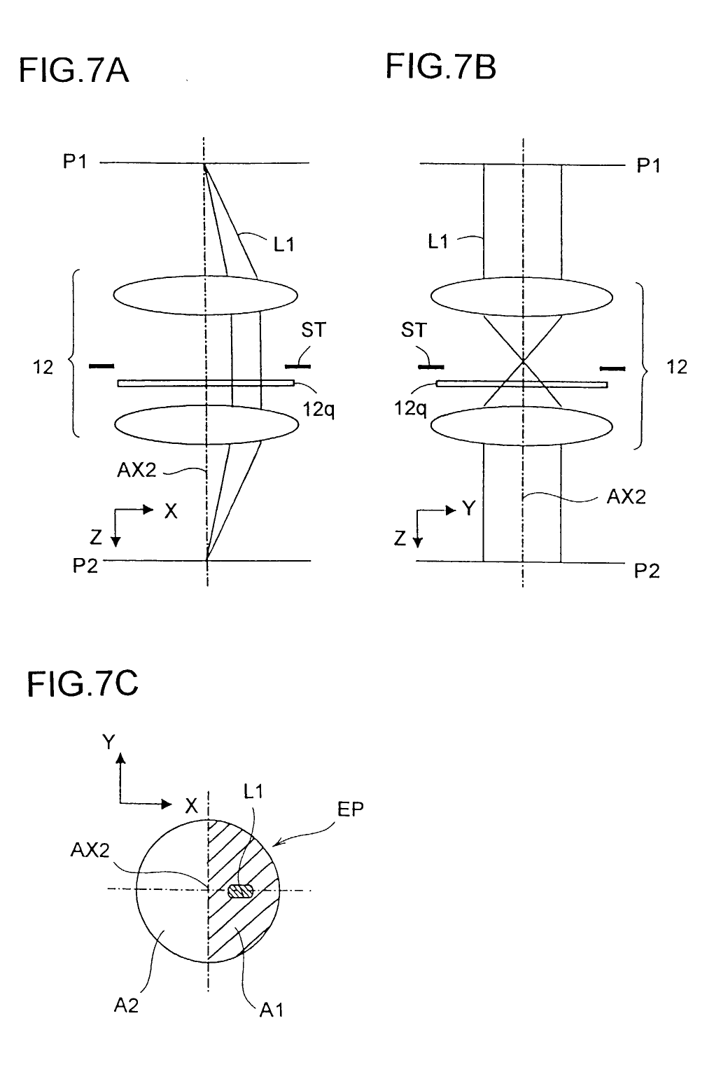

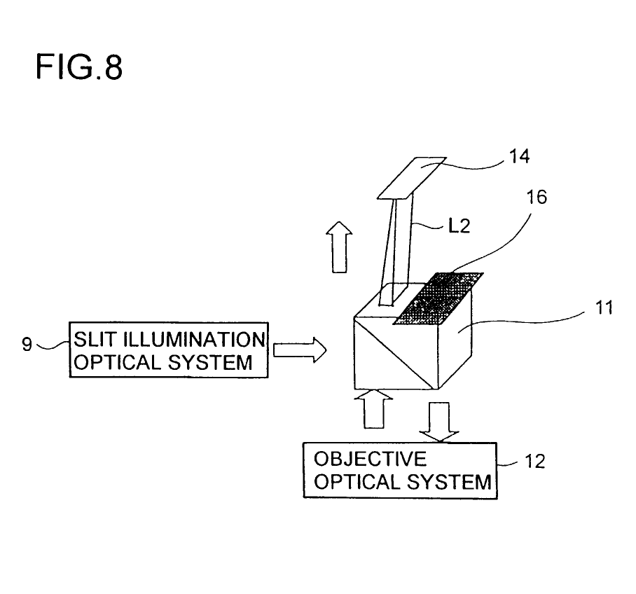

In the three-dimensional shape measuring apparatus 100 shown in FIG. 2, as shown in FIGS. 7A and 7B, the illumination light L1 at all image heights obliquely enters the objective optical system 12 built as a both-side telecentric optical system (ST represents an aperture stop). Then, as shown in FIG. 7C, the illumination light L1 passes through only one half A1 of the pupil EP of the objective optical system 12 relative to its optical axis AX2, and then illuminates the measured surface 15s. The reflected light L2 from the measured surface 15s passes through the other half A2 of the pupil EP, and then exits from the objective optical system 12. The diffusively reflected light R1 in question follows the same path as the illumination light L1 and passes through one half A1 of the pupil EP, but, as shown in FIGS. 2 and 8, it is intercepted by the light-intercepting mask 16 disposed between the polarizing beam splitter 11 and the line sensor 14. In this way, of the reflected light L2 from the measurement object 15, the diffusively reflected light R1 that has passed through the half A1 of the pupil EP is intercepted by the light-intercepting mask 16 serving as a spatial filter. Thus, even when the measured surface 15s is located off the image-side conjugate position P2, the diffusively reflected light R1 produces less measurement noise, contributing higher position measurement accuracy. This construction is effective not only in confocal detection using slit-shaped illumination light but also in confocal detection using pinhole-shaped illumination light.

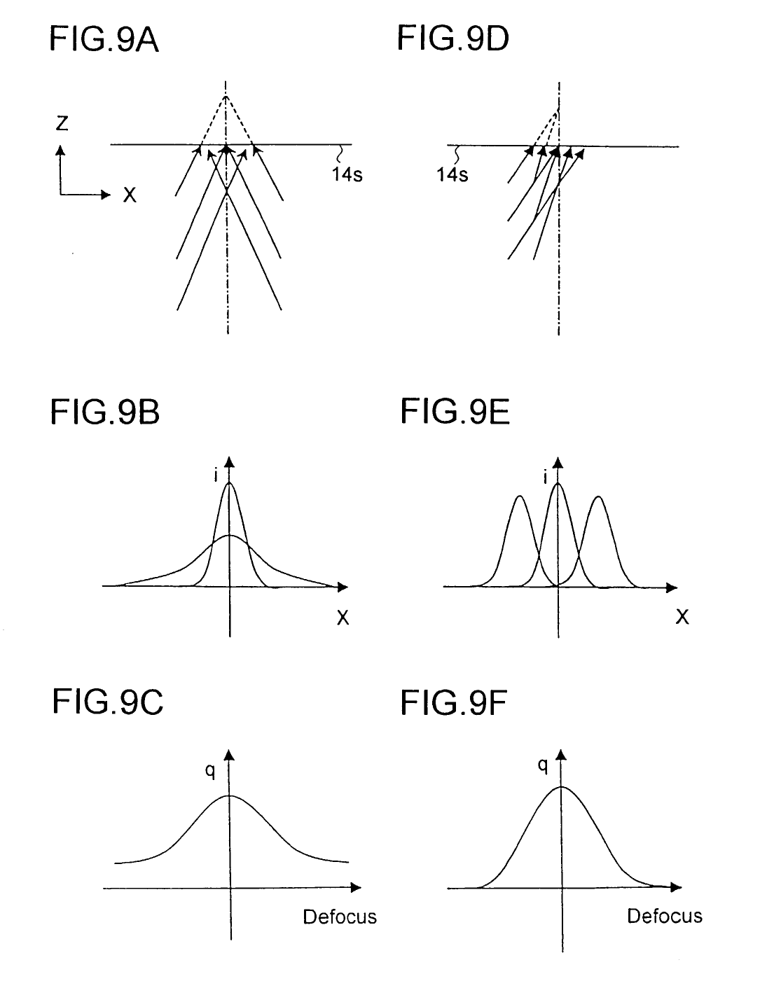

FIGS. 9A to 9C, for the case where full-aperture illumination is adopted, and FIGS. 9D to 9F, for the case where oblique incident illumination is adopted, show the variation of the defocused optical path with respect to the light-receiving surface 14s of the line sensor 14 (FIGS. 9A and 9D), the variation of light intensity distribution (FIGS. 9B and 9E, with i representing light intensity), and the variation of the amount of light detected (FIGS. 9C and 9F, with q representing the amount of light), A comparison between FIGS. 9A to 9C and FIGS. 9D to 9F proves that using oblique incident illumination light L1 results in higher contrast in the variation of the amount of incident light with respect to the defocusing on the light-receiving surface 14s, contributing higher position measurement accuracy. It is advisable to make the illumination light L1 travel as far away from the optical axis AX2 of the objective optical system 12 as possible. This enhances the intercepting effect on the diffusively reflected light R1, and enhances the contrast in the variation of the amount of light detected.

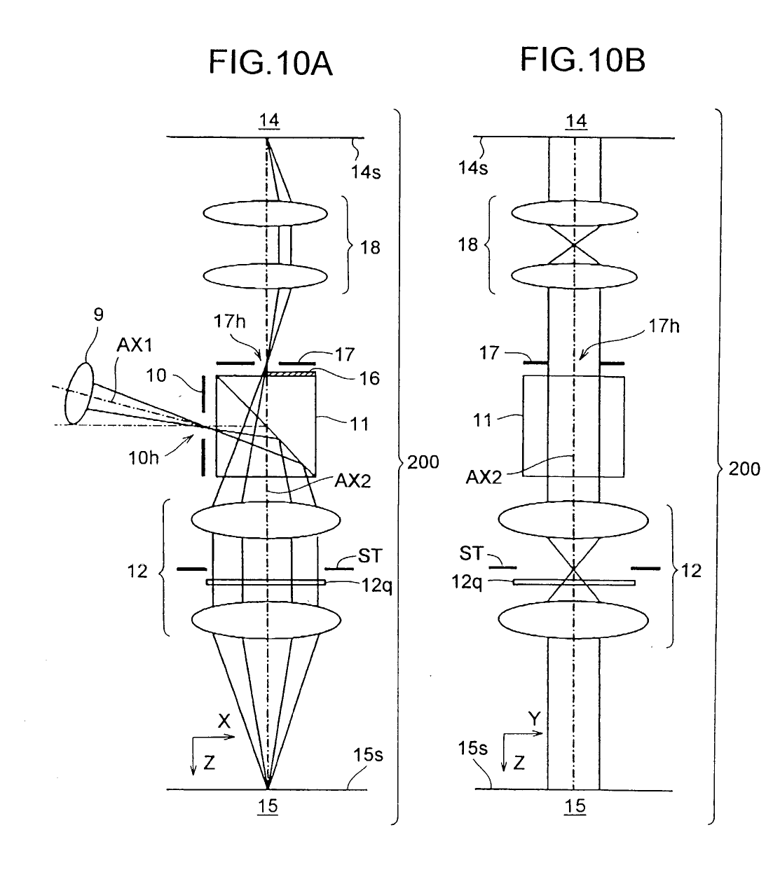

In the three-dimensional shape measuring apparatus 100 shown in FIG. 2, the light-receiving surface 14s of the line sensor 14 is located in a position confocal with the light source image formed at the slit 10h. However, the amount of light may be detected not necessarily in a position confocal with a light source image with respect to the objective optical system 12 but also in a position confocal with a light source itself with respect to the objective optical system 12 (for example, when a slit light source as mentioned earlier is used), or in a position conjugate, with respect to a relay optical system, with a position confocal, with respect to the objective optical system 12, with a light source or an image thereof FIGS. 10A and 10B show a three-dimensional shape measuring apparatus 200 having a relay optical system 18 arranged on the line sensor 14 side. The distinctive features of this three-dimensional shape measuring apparatus 200 are that a slit mask 17 is arranged in a position confocal with the slit mask 10, and that a relay optical system 18 is arranged between the slit mask 17 and the line sensor 14. In other respects, the construction of this three-dimensional shape measuring apparatus 200 is similar to that of the three-dimensional shape measuring apparatus 100 shown in FIG. 2. Here, a slit 17h is located in a position confocal with the slit 10h with respect to the objective optical system 12, and the light-receiving surface 14s of the line sensor 14 is located in a position conjugate with the slit 17h with respect to the relay optical system 18. Using a relay optical system increases the freedom in the placement of the sensor, and also makes it possible to provide an observation optical system (not shown) that permits observation of the measurement target through the objective optical system 12 for three-dimensional shape measurement.

As described above, according to the structure, illumination light is expanded by the use of an anamorphic prism system. This makes it possible to miniaturize a slit illumination optical system, and realize an optical system with satisfactorily small aberrations easily. Moreover, the polarization direction of illumination light is converted by the use of a polarization direction converting device. This helps reduce the loss of light in the anamorphic prism system. As a result, it is possible to realize a three-dimensional shape measuring apparatus provided with a compact slit illumination optical system that produces uniform and intense illumination light, and thereby obtain a uniform dynamic range over the entire measurement area.

Moreover, according to the above-described structure, of the reflected light from the measurement object, the portion which affects the measurement accuracy is intercepted. This makes it possible to measure the height of the measurement object with high accuracy.

What is claimed is:

1. A three-dimensional shape measuring apparatus including:
a point light source for radiating illumination light diverging in a shape of an elliptical cone; and
a slit illumination optical system for imaging the illumination light from the point light source into a shape of a slit,
wherein the slit illumination optical system comprises:
a collimator optical system for converting the diverging illumination light into a parallel beam having an elliptical section;
an anamorphic prism system for expanding the illumination light only in a direction of a major axis of the elliptical section thereof;
a cylindrical optical system for imaging the illumination light only in a direction of a minor axis of the elliptical section thereof; and
a polarization direction converting device for converting a polarization direction of the illumination light so that the illumination light is incident on a prism surface of the anamorphic prism system with a maximum transmittance.

2. A three-dimensional shape measuring apparatus as claimed in claim 1, further comprising:
an optical axis deflector for permitting an imaging position of the illumination light to be fine-adjusted to a desired position, the optical axis deflector being disposed in an optical path of the illumination light after being converted into the parallel beam by the collimator optical system.

3. A three-dimensional shape measuring apparatus relying on confocal detection and including:
a light source for radiating illumination light;
an objective optical system for imaging the illumination light from the light source toward a measurement object and for imaging reflected light traveling back from the measurement object;
a beam splitter for separating an optical path of the illumination light entering the objective optical system and an optical path of the reflected light exiting from the objective optical system; and
a sensor for detecting an amount of the reflected light exiting from the objective optical system,
wherein the illumination light enters the objective optical system obliquely such that the illumination light, when passing through a pupil of the objective optical system, passes through only one half of the pupil relative to an optical axis of the objective optical system, and, of the reflected light from the measurement object, a portion that passes through said one half of the pupil is intercepted.

4. A three-dimensional shape measuring apparatus as claimed in claim 3,
wherein a position in which the sensor detects the amount of the reflected light is confocal with the light source, confocal with an image of the light source, or conjugate with a position confocal with the light source or an image thereof.

5. A three-dimensional shape measuring apparatus as claimed in claim 4, further comprising:
a relay optical system disposed between the sensor and a position confocal with the light source or an image thereof with respect to the objective optical system.

6. A three-dimensional shape measuring apparatus as claimed in claim 3, further comprising:
an illumination optical system for increasing light use efficiency, the illumination optical system being disposed between the light source and the objective optical system.
